(19) United States
(12) Patent Application Publication
(10) Pub. No.: US 2008/0280087 A1
(43) Pub. Date: Nov. 13, 2008

(54) Light-Adjusting Film

(76) Inventor: Yung-Lung Wu, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 12/117,502

(22) Filed: May 8, 2008

(30) Foreign Application Priority Data
May 9, 2007 (CN) 2007200046871

(51) Int. Cl. B32B 33/00; B32B 7/12

(52) U.S. Cl. 428/41.3; 428/354

(57) ABSTRACT

The present invention is related to a light-adjusting film including a light-adjusting film consisted of an anti-dirty layer, a curing layer, two polymer complex layers, a light-adjusting liquid crystal layer, and an attaching layer, wherein the anti-dirty layer provides an dirty-proof function, the curing layer is assembled under the anti-dirty layer, the first polymer complex layer is assembled under the curing layer, the light-adjusting liquid crystal layer is assembled under the first polymer complex layer and connected with a power source, the second polymer complex layer is assembled under the light-adjusting liquid crystal layer, and the attaching layer is assembled under the second polymer complex layer for attaching to a surface of an object. According to the structure above, the present invention is advantageous of easy installation, maintaining and renovation, UV-resisting, heat insulation, great light perviousness, uneasily being damaged and power saving.

### FIELD OF THE INVENTION

The present invention is related to a light-adjusting film, which is assembled by an anti-dirty layer, a curing layer, two polymer complex layers, a light-adjusting liquid crystal layer and an attaching layer, so that through changing the electrification or disconnection state thereof, the light-adjusting film can alter the transparency thereof, thereby the present invention is advantageous of easy installation, maintaining and renovation, UV-resisting, heat insulation, great light perviousness, uneasily being damaged and power saving, and is especially suitable for transparent glass, glazed wall, car dormer, indoor partition or the likes.

### BACKGROUND OF THE INVENTION

In the early stage, for covering the window or the partition glass, and for insulating the sunlight, the methods are to install curtain, use colored glass or adhere heat insulation paper. Take the heat insulation paper as example. Because the heat insulation paper has color, it can achieve a masking effect as attached to a transparent glass, but since it only can insulate partial sunlight, the ultraviolet rays still remain not insulated and the heat is also not insulated well. Besides, the problems of oxidation, non-average, color fading, bubbling, wrinkling and deformation are always happened. Furthermore, if the color of the heat insulation paper is too dark, although a better masking effect is achieved, a bad light perviousness during the cloudy day still might occur, so that people have to adopt another light source. Identically, if the dark beat insulation paper is attached to the car glass, the driver still can not have a good vision. In addition, because the transparency of the colored glass and the heat insulation paper can not be changed arbitrarily, people still might adopt the conventional curtain, which actually has a complicated installation process and a limited installation location, and is difficult to be cleaned.

Recently, a polyvision privacy glass is disclosed which can adjust the transparency thereof through changing the current passing therethrough, so as to arbitrarily alter the light perviousness of the glass. The polyvision privacy glass is a laminated glass, wherein a liquid crystal film is disposed between two pieces of glass, and the two pieces of glass respectively have a conducting film disposed at a surface thereof contacting the liquid crystal film and connected to a power source. The liquid crystal film is a polymer dispersed liquid crystal film which has the light valve characteristic of the liquid crystals. The light valve characteristic is that the liquid crystals do not have an alignment as the liquid crystal film is under a normal condition (which means the liquid crystal film is disconnected with the power source and lacks of applied electric field), so that the reflective index of the liquid crystals is lower than the outside polymers, thereby the incident light is scattered on the polymers and the glass may become milk white, just like a frosted glass. When the liquid crystal film is applied an electric field (connected with the power source), the originally non-aligned liquid crystals are now aligned, so that the reflective indexes of the liquid crystals and the polymers become identical, thereby the incident light can totally pass through the glass, so as to have a transparent state.

However, although the above-described polyvision privacy glass can utilize the current to change the transparency of the glass, the installation thereof has to destroy the original decoration which means an additional construction is needed. Besides, the surface of the polyvision privacy glass might easily become dirty, and has to undergo further processes for resisting UV light and insulating heat, so that the polyvision privacy glass is disadvantageous of complicated structure, high cost, difficult maintaining and renovation, which are needed to be improved.

### SUMMARY OF THE INVENTION

The object of the present invention is to provide a light-adjusting film consisted of an anti-dirty layer, a curing layer, two polymer complex layers, a light-adjusting liquid crystal layer, and an attaching layer, wherein the light-adjusting film according to the present invention can arbitrarily changing the transparency thereof through connecting and disconnecting the light-adjusting liquid crystal layer with the power source, so that the glass attached thereby can preserve the light perviousness for great light vision and also can own the masking function for privacy.

Another object of the present invention is to provide a light-adjusting film which can be directly adhered to a transparent object (such as transparent glass) through the silicone made-attaching layer, for example, it can be attached to a glass without destroying the original decoration and without leaving the gel, so that the light-adjusting film of the present invention is easily installed, maintained and renovated, which increase progressivity and practicability.

Further another object of the present invention is to provide a light-adjusting film which places the light-adjusting liquid crystal layer between two polymer complex layers, which are transparent, have supporting function and can combine the light-adjusting liquid crystal layer with other layers having different efficiencies, so that the light-adjusting film according to the present invention is effective of supporting, attachable, and expandable.

Another further object of the present invention is to provide a light-adjusting film whose anti-dirty layer can improve the dirty-proof capability thereof for easily cleaning the fingerprint and oily pen mark thereon, so that the light-adjusting film according to the present invention can solve the cleaning problems of the general transparent glass through the dirty-proof and easy-cleaning functions thereof, thereby increasing the practicability and convenience.

Still another object of the present invention is to provide a light-adjusting film whose curing layer can not only protect the film itself from being damaged, but also can protect the attached glass from broken, so as to increase protectiveness.

Still further another object of the present invention is to provide a light-adjusting film, which, through assembled with an anti-radiation layer, can resist the ultraviolet and infrared rays for achieving heat insulation, and which, through assembled with an anti-reflection layer, can reduce light reflection and increase light perviousness, for providing the attached glass a greatest light perviousness, so that the indoor temperature can be more suitable for living, thereby reducing the consumption of air conditioning and illumination and also saving energy, so as to conform to environmental consciousness.

For achieving the objects described above, the light-adjusting film of the present invention includes a light-adjusting film consisted of an anti-dirty layer, a curing layer, two polymer complex layers, a light-adjusting liquid crystal layer, and an attaching layer, wherein the anti-dirty layer provides an dirty-proof function, the curing layer is assembled under the anti-dirty layer, the first polymer complex layer is assembled under the curing layer, the light-adjusting liquid crystal layer is assembled under the first polymer complex layer and connected with a power source, the second polymer complex layer is assembled under the light-adjusting liquid crystal layer, and the attaching layer is assembled under the second polymer complex layer for attaching to a surface of an object. Furthermore, an anti-radiation layer is further disposed between the second polymer complex layer and the attaching layer, and an anti-reflection layer is further disposed between the anti-dirty layer and the curing layer. According to the structure above, the light-adjusting layer can be directly attached to a transparent object through the attaching layer and can change the transparency through connecting or disconnecting to the power source, so that the present invention is advantageous of easy installation, maintaining and renovation, UV-resisting, heat insulation, great light perviousness, uneasily being damaged and power saving.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional appearance drawing showing an embodiment according to the present invention;

FIG. 2 is a magnified drawing showing an embodiment according to the present invention;

FIG. 3 is a sectional drawing showing an embodiment according to the present invention; and

FIG. 4 is a schematic view showing the application of an embodiment according to the present invention.

### DESCRIPTION OF THE PREFERRED EMBODIMENT

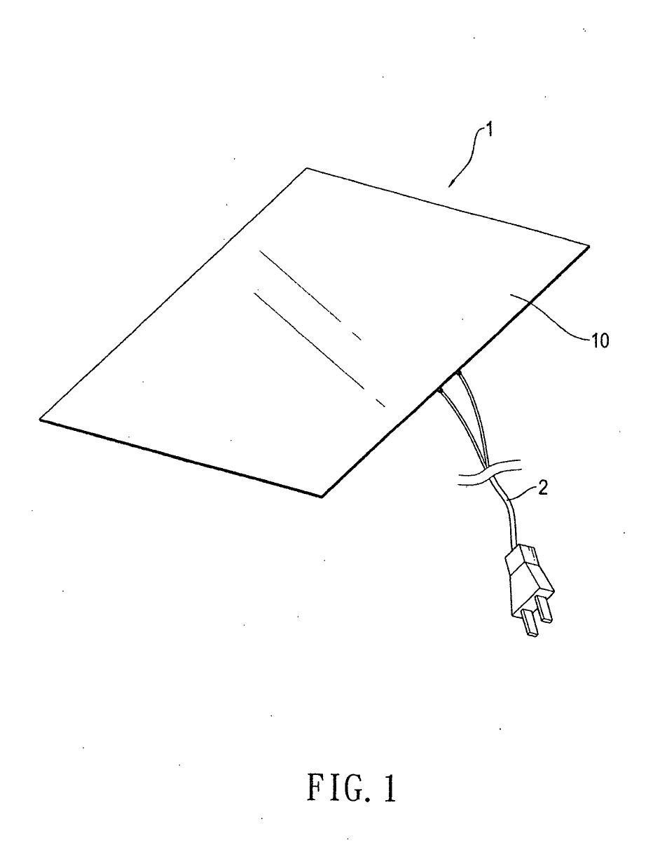

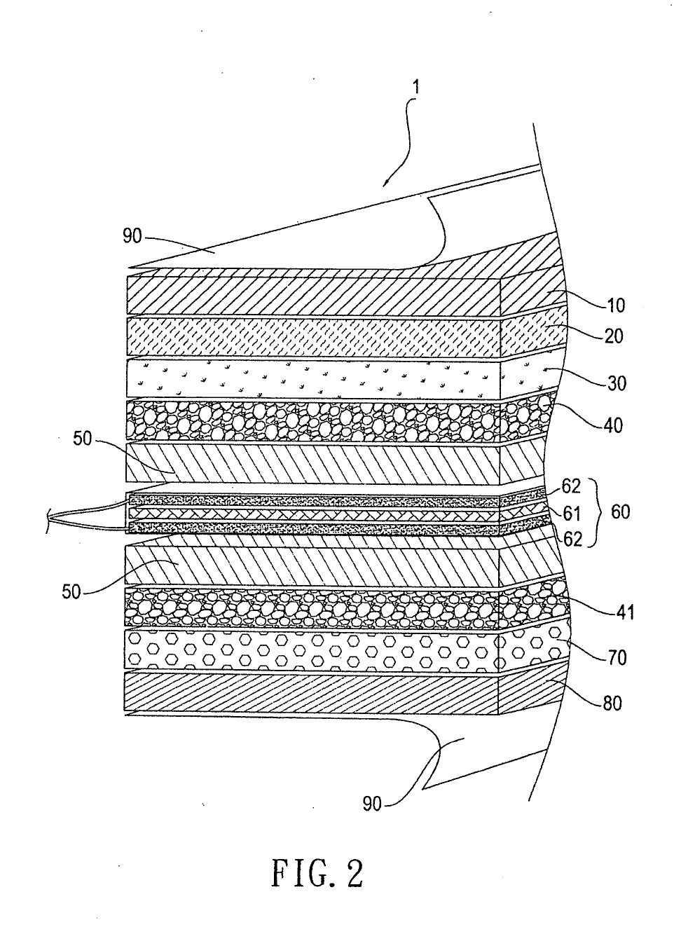

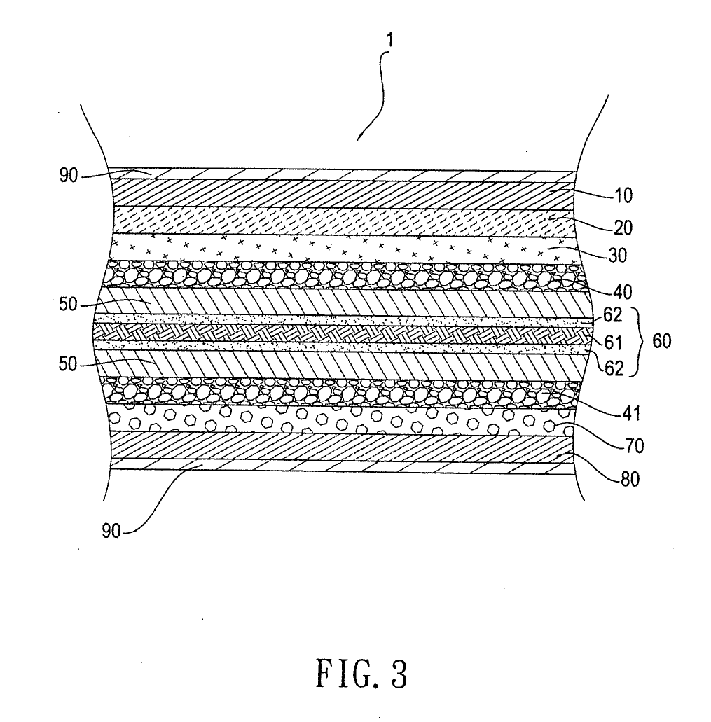

Please refer to FIGS. 1 to 3, a light-adjusting film 1 according to the present invention includes:

a anti-dirty layer 10, for preventing the surface of the light-adjusting film I from dirty;

a curing layer 30, assembled under the anti-dirty layer;

a first polymer complex layer 40, assembled under the curing layer 30, wherein the first polymer complex layer 40 can be made of PET (Polyethylene Terephthalate) or other polymer complex;

a light-adjusting liquid crystal layer 60, assembled under the first polymer complex layer 40 and connected with a power source, wherein the light-adjusting liquid crystal layer 60 includes a liquid crystal layer 61 and two ITO (Indium Tin Oxide) layer 62, and the power source are connected to the two ITO layers 62, and the liquid crystal layer 61 is a polymer dispersed liquid crystal film;

a second polymer complex layer 41, assembled under the light-adjusting liquid crystal layer 60, wherein the second polymer complex layer 41 is made of PET (Polyethylene Terephthalate) or other polymer complexes; and

an attaching layer, assembled under the second polymer complex layer 41, wherein the attaching layer can be made of a silicone.

The light-adjusting liquid crystal layer 60 is assembled with the polymer complex layers 40, 41 through a PSA (Pressure Sensitive Adhesive) 50. Moreover, between the second polymer complex layer 41 and the attaching layer 80, an anti-radiation layer 70 is further assembled which is made of a material capable of resisting ultraviolet and infrared rays at the same time and which can own a color. Furthermore, between the anti-dirty layer 10 and the curing layer 30, an anti-reflection layer 20 is further assembled. In addition, a protection layer 90 is respectively assembled above the anti-dirty layer and under the attaching layer 80, wherein the protection layer 90 is a release film made of PET (Polyethylene Terephthalate), so as to protect the upper and lower surfaces of the light-adjusting film 1 as unused. Accordingly, all the layers described above are integrated together to become the light-adjusting film 1, which can be attached to an object through the attaching layer 80.

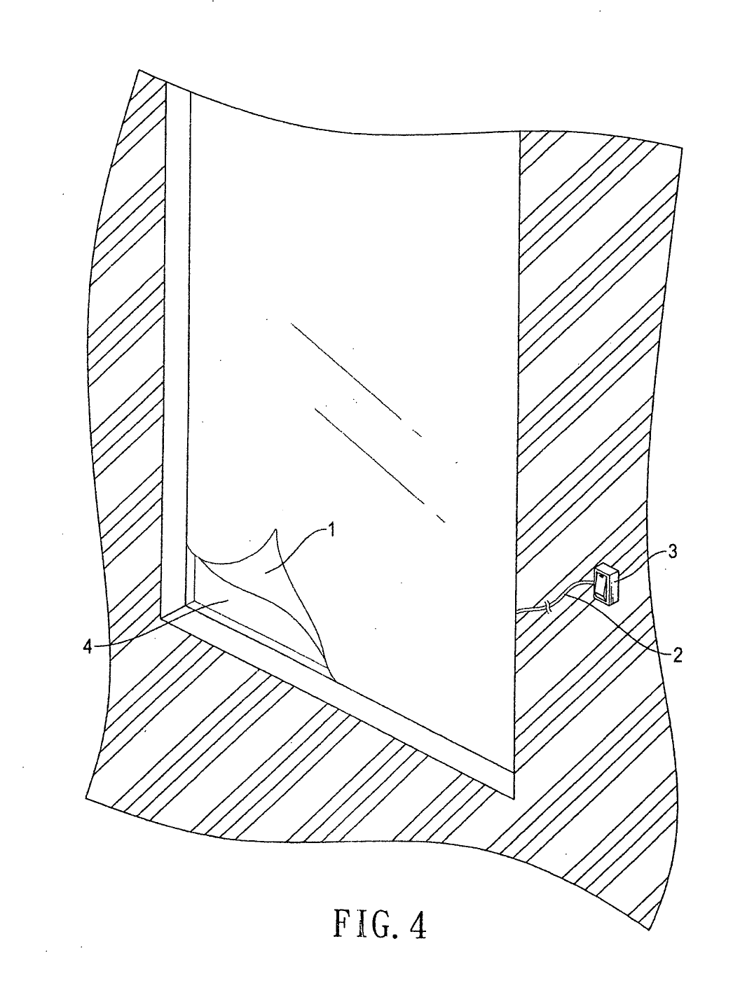

Please refer FIGS. 1 to 4, which show the application of the present invention to a transparent glass. As attaching the light-adjusting film 1 to the transparent glass 4, the protection layer 90 disposed under the layer to be adhered (namely, the attaching layer 80) is released, and the light-adjusting film 1 is adhered to the surface of the glass 4 through the attaching layer 80. Then, the power input terminals (in this embodiment, the power input terminals are the two copper foils connected to the two ITO layers 62) are connected with power lines 2, which are connected to the power source. When the power source switch is turned off, the liquid crystal layer 61 of the light-adjusting liquid crystal layer 60 in the light-adjusting film 1 is disconnected, so that according to the characteristic of liquid crystal light valve, the liquid crystals inside are not aligned, and the reflective index thereof becomes lower than the outside polymers. Therefore, the incident light will be scattered on the polymers to make the light-adjusting film 1 to become opaque milk white, thereby the transparent glass attached by the light-adjusting film 1 looks like the frosted glass. When the power source switch 3 is turned on, the current will pass through the ITO layers 62 above and below the light-adjusting liquid crystal layer 60 to conduct the liquid crystal layer 61, so that the is originally non-aligned liquid crystals are now aligned, which causes the liquid crystals and the polymers have the same reflective index. Therefore, the incident light can totally pass through the glass for making the light-adjusting film to become transparent, and the original color and luster of the glass to be attached can be showed.

The characteristic of the light-adjusting film 1 according to the present invention is that after processing, the liquid crystal light valve becomes a film which can be directly attached to a transparent substrate (such as transparent glass), through combining the polymer complex layers 40 and 41 to the light-adjusting liquid crystal layer 60 by the PSA 50 and the supporting provided by the polymer complex layers 40, 41, the light-adjusting film I can be combined with all kinds of substrates, and owing to the anti-radiation layer 70, the light-adjusting film 1 may have different colors as opaque. The light-adjusting film 1 according to the present invention, through changing the conduction state of the liquid crystal layer 61 therein, can have a transparent state as the power source is turned on, and have an opaque state as disconnected with the power source. Therefore, when attaching the light-adjusting film 1 to a transparent glass which is applied to the outdoor glazed wall or the indoor partition, the requests of light perviousness and privacy masking both can be achieved. Moreover, when the light-adjusting film 1 becomes opaque (such as milk white), the partition glass 4 attached by the light-adjusting 1 can be served as a projection screen or a white board, and through the anti-dirty layer 10, it will be convenient to clean the dirt on the surface, such as, fingerprint or oily pen mark, and further, through the curing layer 30 under the anti-dirty layer 10, the light-adjusting film 1 can have a surface that is not easily damaged, so as to protect the attached glass from broken. Through the anti-radiation layer 70, the ultraviolet and infrared rays in the sunlight can be separated, so that the attached glass can achieve the effects of UV-protection and heat insulation. Furthermore, the anti-reflection layer 20 can reduce light reflection and increase light transparency, so that the light-adjusting film 1 can have a great light perviousness. Besides, since the attaching layer 80 can be made of silicone, which can be repeatedly adhered without leaving gels and can exclude the bubbles easily, the light-adjusting film 1 can be directly adhered to the surface of transparent object (such as, transparent glass) for facilitating maintaining and renovation. Accordingly, the present invention is advantageous of easy installation, maintaining and renovation, changeable transparency, dirty-proof, UV resisting, heat insulating, great light perviousness, uneasily being damaged and power saving, so as to be practical and convenient.

Consequently, the light-adjusting film of the present invention is advantage that:

1. It can be directly installed without re-construction, so that the original decoration will not be damaged, and since the cost thereof is lower than the convention polyvision privacy glass, the present invention is advantageous of easy to use, maintain and renovate.

2. When the light-adjusting film is attached to a transparent glass, through switching between the connection and disconnection to the power source, the transparency of the light-adjusting film can be changed to be transparent or opaque, so that the requests of light perviousness and privacy masking both can be reserved, and even the light-adjusting film becomes opaque, the indoor natural light is still sufficient.

3. The light-adjusting film of the present invention can be widely applied to glazed wall, car dormer, and indoor partition etc. If being applied to the partition, the light-adjusting film will become opaque as disconnected with the power source, and then the attached glass can be served as projection screen for saving the installation inconvenience. This shows the multiple functionalities of the present invention,

4. Through assembling an anti-dirty layer in the light-adjusting film, it makes the surface of the light-adjusting film to be cleaned more easily, and if the light-adjusting film is adhered to the transparent glass, the cleaning trouble can be significantly reduced, so as to increase the convenience and practicality.

5. Through assembling with the anti-radiation layer, the light-adjusting film owns the functions of ultraviolet and infrared rays resisting. If being applied to the glazed walls of building, the UV damage to human skin and indoor furniture can be reduced since UV-light in sunlight is separated, and the effect of heat insulation can also be achieved since the infrared rays are separated, too. Thereby, the indoor temperature becomes more suitable for living demands, which reduces the consumption of air conditioning, so as to effectively save energy and conform to environmental consciousness.

6. The assembled anti-reflection layer can reduce light reflection and increase light transparency of the light-adjusting film, so that the light-adjusting film can have a great light perviousness. If being applied to the glazed walls of building, it can acquire sufficient light inside the house, so as to save illumination power.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light-adjusting film, comprising:
an anti-dirty layer, for providing an dirty-proof function;
a curing layer, assembled under the anti-dirty layer;
a first polymer complex layer, assembled under the curing layer;
a light-adjusting liquid crystal layer, assembled under the first polymer complex layer and connected with a power source;
a second polymer complex layer, assembled under the light-adjusting liquid crystal layer; and
an attaching layer, assembled under the second polymer complex layer for attaching to a surface of an object.

2. The light-adjusting film as claimed in claim 1, wherein the light-adjusting liquid crystal layer comprises a liquid crystal layer and two ITO (Indium Tin Oxide) layers, and the two ITO layers are respectively assembled above and below the liquid crystal layer and are both connected to the power source.

3. The light-adjusting film as claimed in claim 2, wherein the liquid crystal layer of the light-adjusting liquid crystal layer is a polymer dispersed liquid crystal film.

4. The light-adjusting film as claimed in claim 1, wherein an anti-reflection layer is further disposed between the anti-dirty layer and the curing layer.

5. The light-adjusting film as claimed in claim 1, wherein an anti-radiation layer is further disposed between the second polymer complex layer and the attaching layer.

6. The light-adjusting film as claimed in claim 5, wherein the anti-radiation layer is a layer capable of resisting ultraviolet and infrared rays at the same time.

7. The light-adjusting film as claimed in claim 1, wherein the polymer complex layers above and below the light-adjusting liquid crystal layer are assembled through a PSA (Pressure Sensitive Adhesive).

8. The light-adjusting film as claimed in claim 1, wherein the polymer complex layers above and below the light-adjusting liquid crystal layer are made of PET (Polyethylene Terephthalate).

9. The light-adjusting film as claimed in claim 1, wherein a protection layer is respectively disposed above the anti-dirty layer and below the attaching layer, and the protection layer is a release film made of PET (Polyethylene Terephthalate).

10. The light-adjusting film as claimed in claim 1, wherein the attaching layer is made of silicone.
